(19) United States
(12) Patent Application Publication
(10) Pub. No.: US 2003/0063227 A1
(43) Pub. Date: Apr. 3, 2003

(54) Integrated modular projection television system

(76) Inventor: Jeffrey G. Whitelaw, Corona, CA (US)

Correspondence Address: ORRICK, HERRINGTON & SUTCLIFFE, LLP, 4 PARK PLAZA, SUITE 1600, IRVINE, CA, 92614-2558, US

(21) Appl. No.: 10/215,864

(22) Filed: Aug. 9, 2002

Related U.S. Application Data
(63) Continuation-in-part of application No. 09/970,967, filed on Oct. 3, 2001.

(51) Int. Cl. H04N 5/64

(52) U.S. Cl. 348/787

(57) ABSTRACT

The present invention is directed to an improved projection television system that integrates entertainment center cabinetry used to store electronic devices, media, and the like, with a projection television enclosure. The system of the present invention accommodates projection televisions of varying screen sizes, while using substantially the same entertainment center cabinetry. Accordingly, in one innovative aspect, the system incorporates interchangeable projection television screens and cabinetry that is adjustable to accommodate screens of different dimensions. The cabinetry is integrated into the enclosure of the projection television set as opposed to being stand alone, or separate, entertainment center cabinetry.

### CROSS-REFERENCE OF RELATED APPLICATION

This application is a continuation-in-part of U.S. patent application Ser. No. 09/970/967, which is incorporated herein by reference.

### FIELD OF THE INVENTION

The present invention relates generally to projection television sets, and more particularly to an integrated, modular projection television set enclosure and entertainment system.

### BACKGROUND

Projection television (PTV) sets are a popular alternative to picture tube television sets, as they provide relatively large viewable screens that cannot be efficiently produced using conventional picture tubes. PTV sets typically include an enclosure housing an optical unit, a mirror, and electronic components for receiving and projecting an image onto a screen assembly mounted on the front of the enclosure. The optical unit typically includes three projection tubes having a cathode ray tube (CRT) optically coupled to a projection lens. The three projection tubes preferably project red, green, and blue images on to the screen of the PTV.

The conventional PTV enclosures typically include top, bottom, side, front and rear panels and are typically divided into two compartments, an upper and a lower compartment. The CRTs and the printed wiring boards (PWB) are typically mounted in the lower compartment, the mirror and screen are mounted in the upper compartment, and the projection lens tends to extend from the lower compartment to the upper compartment.

As typical PTV enclosures tend to be larger than picture tube television set enclosures, owners of PTVs tend to purchase or build custom cabinetry to house the PTV and create an entertainment center. The typical entertainment center includes an opening for the PTV enclosure and a tower unit adjacent each side of the opening, and thus the PTV. The tower units, which comprise a plurality of shelves, are used to store consumer electronics used apart and in conjunction with the PTV, such as, e.g., digital video disk players, video cassette records, amplifiers, and a variety of audio components, as well as e.g., DVDs, videotapes, CDs, cassette tapes, and the like. There are, however, several disadvantages with current entertainment centers. First, once the entertainment centers are installed they become limited or fixed in size, unable to accommodate different size PTVs. For example, if the owner of an entertainment center purchases a larger size PTV, the owner would likely need to purchase or build a new entertainment center if the current unit does not accommodate the larger PTV. The cost, however, associated with tearing out and replacing the entertainment center with a larger unit can be quite high especially with custom-built entertainment centers built to fit the specifications of a particular room or wall and PTV. Second, current entertainment centers do not provide convenient or efficient methods for interconnecting various electronic devices and the PTV. In general, connecting and using a large number of devices with the PTV results in a mass of bulky wiring that the owner must then conceal, typically by placing the wiring behind the entertainment center. This results in a potential detraction from one purpose of using an entertainment center, namely, presenting the PTV in a visually pleasing manner. The problem of bulky wiring is heightened if the PTV has audio/visual connections disposed on the front of the console.

Therefore, it would be desirable to provide for a modular, integrated PTV entertainment center system that is expandable, and upgradable, or reducible in size to fit PTVs of a variety of dimensions without the need for replacing the cabinetry or shelving. A user may wish to reduce the size of the system after moving to a smaller living space or rearranging the unit itself to a smaller room. Similarly, a user may desire to increase the size of the system in order to enjoy a PTV having a larger screen size. It would also be desirable to provide for a modular, integrated PTV entertainment center system that reduces the need for bulky and extensive wiring to connect various devices to the PTV.

### SUMMARY OF THE INVENTION

The present invention is directed to an improved projection television (PTV) system that integrates entertainment center cabinetry for storage of electronics devices, media, and the like, with a projection television enclosure. The system of the present invention accommodates projection televisions of varying screen sizes, while using substantially the same cabinetry.

In one innovative aspect of the present invention, the side panels of the PTV and the inner side panel of the cabinetry of an entertainment center are detachably coupleable to one another.

In another innovative aspect of the present invention, the side panels of the PTV are integral components of the cabinetry of an entertainment center. A plurality of other side panels and shelving may be utilized to form a customized entertainment system. The system tends to eliminate the need to construct or purchase costly separate structures to house a PTV.

In a preferred embodiment, the integrated, modular projection television system of the present invention combines a PTV with cabinetry that is integrated into the projection television system. The PTV includes a screen, front and rear panels, and a plurality of side panels that are detachably coupleable to the inner side panel of the cabinetry of the entertainment center. Alternatively, the PTV includes a screen, front and rear panels, and a plurality of side panels, wherein the side panels also function as inner side panels of the cabinet system. The television also includes a mirror and an optical system optically coupled to the screen. The cabinetry portion of the system comprises a plurality of outer side panels that are positioned in spaced relation to the side panels of the projection television set, i.e., the inner side panels of the system, a plurality of shelf panels that may be located at various positions within the cabinet system, top panels that extend over both the cabinet system and the projection television set, rear panels that are located between the inner and outer side panels toward the rear portions of those panels, a bottom panel extending the length of the system, and, optionally, a toe rail that extends along the entire bottom length of the system.

In another embodiment, the screen of the projection television portion of the system is interchangeable with a substitute screen of a different size. For example, the screen is replaceable with a screen of a larger dimension. After replacement of the screen, substantially the same cabinetry is used with the system, thereby enabling the system to accommodate screens of varying sizes without requiring the acquisition or use of new entertainment center cabinetry.

In a further embodiment, a bus extends along the inner side panel of the cabinetry to enable communication between electronic components supported in the cabinetry and the PTV. The bus preferably includes a power transmission line and IEEE 1394 wiring.

Other objects and features of the present invention will become apparent from consideration of the following description taken in conjunction with the accompanying drawings.

### BRIEF DESCRIPTION OF THE DRAWINGS

FIG. 1a is an illustration of an embodiment of the system of the present invention, showing the cabinets of the system unattached to the PTV of the system.

FIG. 1b is an illustration of the system of FIG. 1a with the cabinets attached to the PTV of the system.

FIG. 2 is an illustration of a system of the present invention having cabinetry portions that elevate above the PTV portion of the system.

FIG. 3 is an illustration of another embodiment of a system of the present invention.

FIG. 4 is an illustration of the system shown in FIG. 3 that also includes glass doors disposed on the front of the cabinetry portion of the system.

FIG. 5 is an illustration of a system of the present invention that is expandable using a plurality of cabinetry portions.

### DETAILED DESCRIPTION

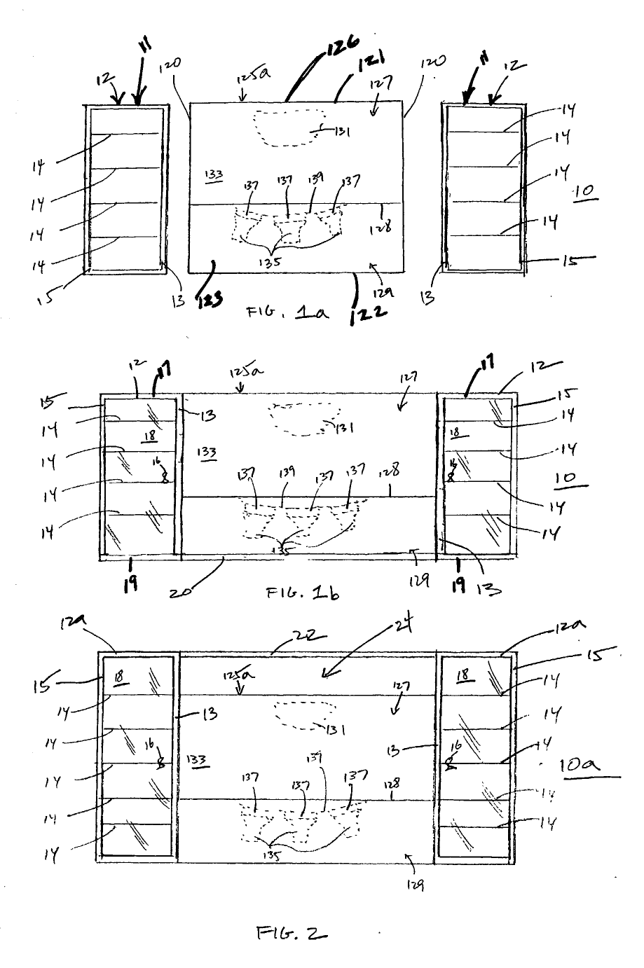

Referring in detail to the figures, an integrated, modular projection television system 10 of the present invention is shown in FIGS. 1a and 1b. The modular system 10 includes a projection television (PTV) 125 and cabinetry 12 that detachably couples to the PTV 125 using suitable attachment components.

The PTV 125 of the system 10 includes a typical PTV enclosure 126 comprising an upper compartment 127 and a lower compartment 129 bounded by front 123, rear, top 121, bottom 122, and side 120 panels and a screen 133. Within the upper compartment 127 of the enclosure 126 is a mirror 131 that is oriented to reflect light images onto the screen 133. The screen 133 is incorporated, into, placed within, or mounted on the front panel 123 and between the side panels 120 of the PTV 125 of the system 10 in a manner known in the art. A partition 128 divides the upper compartment 127 from the lower compartment 129 and prevents dirt and other contaminants from entering the upper compartment 127. Within the lower compartment 129 is an optic system that may include a plurality of cathode ray tubes (CRTs) 135, projection lenses 137 attached to each CRT 135, and a bracket 139 that holds each projection lens 137 and CRT 135 in place within the lower compartment 129 at its correct angular orientation. Preferably, the CRTs project light images comprising the colors red, green and blue. Alternatively, the optic system may comprise a light source, a color wheel, and a plurality of micro-mirrors.

As discussed above, the PTV 125 includes a pair of side panels 120. The side panels are preferably adapted to releasably couple to and become integrated with the cabinetry of an entertainment center. However, to accommodate those customers not wishing to integrate the PTV with cabinetry of an entertainment center, the PTV may be supplied with basic side panels with typical surface finishes to form a typical PTV enclosure. The basic side panels, however, are preferably detachable from the enclosure to allow for the attachment of the side panels 120 of the present invention to enable the PTV 125 to be integrated with the cabinetry of an entertainment center when desired.

The modular system 10 of the present invention preferably includes cabinetry 12 that is adapted to be releasably coupled to the side panels 120 of the PTV 125. In FIG. 1b, the system 10 is shown in operating form, i.e., FIG. 1b illustrates a fully assembled system 10 with the cabinetry 12 attached to the PTV 125. The side panels 120 of the PTV 125 and inside walls 13 of the cabinetry 12 include attachment components adapted to releasably couple the side panels 120 and inside walls 13. When attached together, the PTV 125 and cabinetry 12 form an integrated system 10 capable of being utilized as an entertainment system housing audio/video components, a bookshelf, and the like. The PTV 125 and cabinetry 12 may be attached to each other using a variety of suitable fasteners or attachment components, such as, e.g., brackets, bolts, screws, dolls, tongue and grooves, and the like. Preferably, the fasteners or attachment components used to attach the side panels 120 of the PTV 125 and the inside walls 13 of the cabinetry 12 do not result in permanent engagement of the PTV 125 and cabinetry 12. For example, the cabinetry 12 may preferably be detached from the PTV 125 and subsequently attached to a PTV of different size and/or shape. Similarly, the cabinetry 12 may be detached from the PTV 125 and substituted or used with substituted cabinetry portions to form different sized cabinetry. The system 10 of the present invention advantageously provides the PTV user the flexibility in sizing the cabinetry 12 of an entertainment center to fit PTVs of various sizes and not locking the PTV user into sizing a PTV to fit the cabinetry of an entertainment center.

In order to form an entertainment center, book case, or the like, the cabinetry 12 of the modular system 10 of the present invention preferably includes one or more towers 11 mounted on one or both sides of the PTV 125. The towers 11 are formed by interconnecting the inside wall panels 13, which detachably couple to the side panels 120 of the PTV 125, with top and bottom panels 17 and 19, and outside wall panels 15. A plurality of shelves 14 is preferably positioned at various elevations within each tower 11. The inside surfaces of the side walls 13 and 15 preferably include a plurality of corresponding holes used to position the shelves 14 within the tower 11. Brackets, dowels or other shelf-supporting components may be inserted and secured into these holes at the levels at which it is desired to position the shelves 14. A shelf 14 is then placed over the brackets or other shelf-support component at the desired elevation. The shelves 14 and top and bottom panels 17 and 19 may vary in size and shape to allow the customization a system owner may desire. For example, the shelves and panels may be 18″ or 24″ in depth (or some other size) and may be rectangular, curved or some other shape.

As seen in FIG. 1b, one embodiment of system 10 further includes a toe rail 20 that extends along the length of the entire system 10 and attaches to the bottom portions of the PTV 125 and the cabinetry 12. Preferably, the toe rail 20 is temporarily, i.e., not permanently, attached to the cabinetry 12 so that a differently sized toe rail 20 may be substituted if and when the size of the PTV 125 is varied. Also, the toe rail 20 is preferably secured to at least each outside wall 15 of the cabinetry 12, but may be secured at other points along the bottom edge of system 10, such as, e.g., to the inside walls 13 and along the bottom portion of the PTV 125. When utilized, the toe rail 20 assists in maintaining the structural integrity of system 10. In one embodiment, the toe rail 20 is also designed as a decorative molding for the bottom edge of system 10.

Turning to FIG. 2, the cabinetry 12 of the modular the system 10 is shown as extending above the PTV 125. To add structural integrity to the system 10, a top rail 22 is provided that attaches to the top of the cabinetry 12. Preferably, the top rail 22 is temporarily, i.e., not permanently, attached to the cabinetry 12 so that a differently sized top rail may be substituted if and when the size of the PTV 125 is varied. In addition to the top rail 22, a top panel may be provided, which extends above the PTV 125 between the inside walls 13 or the outside walls 15 of the towers 11. As a result of the cabinetry 12 extending above the top of the PTV 125, the system 10 provides a space 24 above the PTV 125 usable for placing consumer electronic components, such as, e.g., a cable controller, a satellite controller, a DVD player, a VCR player, a video game console, an internet appliance, or the like, atop the PTV 125. Although not shown in FIG. 2, a toe rail similar to the toe rail 20 may also be provided with the system 10 to increase the structural integrity of the system 10 and for decorative purposes.

The panels, walls, shelves, rails, and the like, of the PTV 125 and cabinetry 12 of system 10 of the present invention may be constructed out of a wood-based material, such as, e.g., particle board. Alternatively, the panels, walls, shelves, rails and the like, may be formed of extruded plastic, polystyrene, and the like. A suitable method of forming panels from polystyrene is described in commonly owned and copending U.S. application Ser. No. 09/652,716, entitled “Enclosure for Projection Television Sets,” which is fully incorporated herein by reference.

Because the side panels 120 of the PTV 125 are not visible when the system 10 is in completed form, the side panels 120 do not need to have finished surface, which tends to reduce manufacturing costs. Similarly, because the surface of the inside walls 13 of the cabinetry 12 adjacent the PTV 125 is also hidden from view after the cabinetry 12 is attached to the PTV 125, it also may remain unfinished.

The cabinetry of the system 10 also preferably includes doors 18 that are positioned at the front of the cabinetry 12. The doors 18 are preferably secured to hinges that are located on a front edge of the inside 13 or outside 15 walls of the cabinetry 12. When in a closed position, a latch on a front edge of the inside 13 or outside 15 walls of cabinetry 12 secures the door 18 in a closed position. The latch may be, for example, a magnet that attracts a metal plate located on the door 18, or a catch that secures a protrusion located on the door 18. Preferably, door 18 is constructed primarily of glass that is set within a frame. The frame is preferably formed from the same material as the other portions of system 10. When constructed using glass, or a similar material that does not block infrared or radio signals, the door 18 allows signals to be sent by a user from a suitable remote control, to various electronic components and devices, that may be stored within the cabinetry 12 of the system 10. Also, door handles 16 are preferably provided in order to facilitate the opening and closing of the doors 18.

In addition, a preferred embodiment of the system 10 of the present invention includes a bus arrangement providing easy connectivity and communication between individual electronic components housed in the towers 11 and between individual electronic components and the PTV 125. The bus preferably includes a power transmission line to provide power to the individual electronic components housed in the towers 11. The bus also preferably includes IEEE wiring to accommodate PTVs and electronic components that are adapted to communicate over such architecture. Preferably, the bus is mounted in or along the inside walls 13 of the cabinetry 12 and is adapted to interconnect to the PTV 125, a power source, and a signal input. The bus also preferably includes a plurality of communication ports and power outlets disposed along the bus at appropriate elevations within the towers 11 to enable the various electronic components supported on various shelves 14 within the cabinetry to easily connect to the bus to receive power and communicate with other components. The bus advantageously reduces the tangle of wires typically located behind most PTVs and entertainment centers.

In an alternative embodiment of system 10, a plurality of access openings are provided along a rear panel and/or in the shelves 14 of the cabinetry 12. The access openings along the rear panel and in the shelves 14 allow for any necessary wiring or cables to be routed from devices placed within the cabinetry 12 and outside of the cabinetry 12 and subsequently to input/output ports that may be disposed on a rear surface of the PTV.

The system 10 may further include light fixtures disposed within the cabinetry 12. In these embodiments, the light fixtures are preferably mounted on the underside of a top panel of the cabinetry 12. In one embodiment, the system 10 may also include light fixtures disposed on the underside of the top rail 22.

Referring now to FIG. 3, an integrated, modular projection television system 100 of the present invention is illustrated. The components of the PTV 125 of system 100 are substantially the same as the PTV 125 described with respect to system 10 with the exception of the side panels. In this embodiment, the PTV 125 includes side panels 141 that also form the innerside panels for the cabinetry 150 of the system 100. As a result, both the cabinetry 150 and the PTV 125 of this embodiment may preferably be adjustable in size. For example, the PTV 125 owner may desire to increase the screen size of the PTV 125. A kit, which includes the larger screen and corresponding PTV enclosure panels or extensions, may be provided to the owner to enable the owner to adjust the size of the PTV 125. By adjusting the size of the PTV 125, the size of the cabinetry 150 is effectively adjusted. However, the same kit, or a separate kit, which includes appropriately sized shelving or additional shelving and side panels, may be provided to further alter the size or configuration of the cabinetry 150. This embodiment advantageously provides the PTV 125 owner with greater flexibility in configuring an entertainment center that meets the owner's current needs.

The cabinetry 150 of the system 100 includes outer side panels 143 opposite each inner side panel 141. The inner side panels 141 and outer side panels 143 are connected at a rear edge to a rear panel 145. A bottom panel 147 is also provided to which each inner side panel 141, each outer side panel 143, and each rear panel 145 are attached. The bottom panel 147 also provides a support for the PTV 125 of the system. For example, lower compartment 129 of the PTV 125 is preferably placed on top of bottom panel 147.

The system 100 further includes outer top panels 151 that extend between each pair of the inner 141 and outer 143 side panels. Also included with system 100 is a middle top panel 153 that extends between the inner side panels 141.

A plurality of shelf panels 149 are also provided that may be positioned at various points between each pair of outer 143 and inner 141 side panels. The outer 143 and inner 141 side panels include a plurality of holes through which brackets or other shelf-supporting means may be inserted and secured. The brackets or other shelf-supporting means are inserted into the holes corresponding to the desired level at which the shelf panels 149 are to be placed. A shelf panel 149 is then placed over the brackets or other shelf-support means at a particular level of holes.

Turning back to FIG. 3, the illustrated embodiment of the system 100 also includes a toe rail 181 that extends along the length of the entire system 100 and attaches to the bottom area of system 100. Preferably, the toe rail 181 is secured at least to each outer side panel 143 and bottom panel 147. The toe rail 181 may also be secured to system 100 at other points, such as, e.g., to the inner side panels 141. The toe rail 181 assists in maintaining the structural integrity of the system 100 along the bottom edge of the system 100. The toe rail 181 may also be designed as a decorative molding for the bottom edge of the system 100.

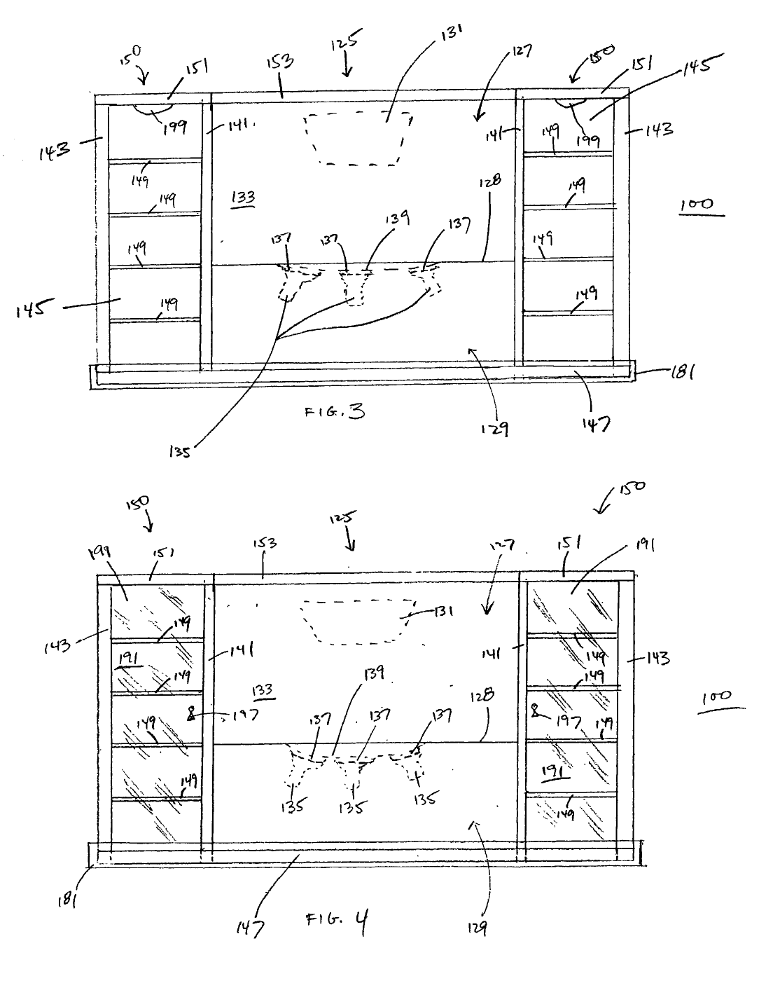

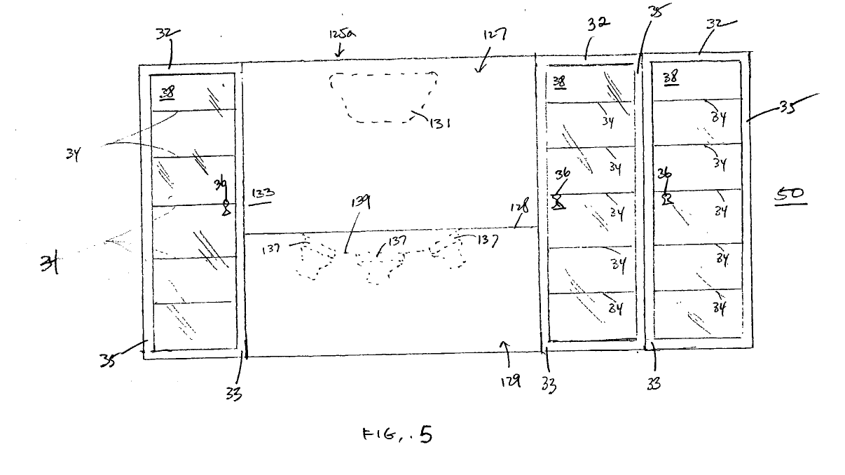

Turning now to FIG. 4, the system 100 is shown including doors 191 that attach to the front edges of the inner 141 and outer 143 side panels. As with the system 10, the doors 191 are preferably constructed primarily of glass that is set within a frame. Also, as illustrated in FIG. 4, door handles 197 are preferably provided in order to facilitate the opening and closing of the doors 191.

With respect to materials of manufacture, the panels, i.e., the inner side panels 141, the outer side panels 143, the rear panels 145, the shelf panels 149, the bottom panel 147, the outer top panels 151, and middle top panel 153, may be constructed of a wood-based material, such as, e.g., particle board, or formed of extruded plastic or polystyrene.

As with the system 10 discussed above, a preferred embodiment of the system 100 of this embodiment includes a bus arrangement providing easy connectivity and communication between individual electronic components housed in the cabinetry 150 and between individual electronic components and the PTV 125. The bus preferably includes a power transmission line to provide power to the individual electronic components housed in the cabinetry 150. The bus also preferably includes IEEE 1394 wiring to accommodate PTVs and electronic components that are adapted to communicate over such architecture. Preferably, the bus is mounted in or along the inner side walls 141 of the cabinetry 150 and is adapted to interconnect to the inputs and outputs of the PTV 125, a power source, and a signal input. The bus also preferably includes a plurality of communication ports and power outlets disposed along the bus at appropriate elevations within the cabinetry 150 to enable the various electronic components supported on various shelves 149 within the cabinetry to easily connect to the bus to receive power and communicate with other components.

Turning back to FIG. 3, the system 100 may further include light fixtures 199 disposed within the cabinetry portions 150. In embodiments that include light fixtures 199, the light fixtures 199 are preferably mounted on the bottom surface of the outer top panels 151.

In another embodiment, the system 100 further includes a plurality of speakers that are components of a surround sound system. Front right, front left, and front center channel speakers may be located atop the outer top panels 151 and the middle top panel 153, respectively. In this embodiment, the outer top panels 151 and middle top panel 153 preferably include access openings that enable speaker wiring to be routed from the speakers to within the interior of the cabinetry 150. The speaker wiring is then routable separately or through the bus to an amplifier located within the cabinetry 150 or directly to the projection television if the television is capable of powering external speakers. Additionally, speaker wiring for a rear left channel speaker, a rear right channel speaker, and a subwoofer located external to system 100 may be routed from within the cabinetry 150 through the access openings in the outer top panels 151 and middle top panel 153 and subsequently to those speakers.

In practice, the present invention enables a user to upgrade to a larger size television, or downsize to a smaller size television, without the need to invest in different size entertainment centers or install new built-in cabinetry to accompany the new television. For example, in one embodiment of the present invention, when upgrading to a larger size television to replace one already implemented in the system 100, a user is provided simply with a suitable larger size screen (not shown), a middle top panel that is substantially equal in length to the larger screen (not shown), and a bottom panel that is substantially equal in length to the length of the larger screen in addition to the cabinetry portions 150 (not shown). The user would then substitute the smaller, first screen 133 with the new, larger screen, the smaller, first middle top panel 153 with the new, longer middle top panel, and the first bottom panel 147 with the new, longer bottom panel. Additionally, if a toe rail 181 was originally used, the user may be provided with, and replace the toe rail 181 with, a new, longer toe rail that is sufficient in length to span the length of the new, longer bottom panel. The new panels are then secured to the other, original panels using suitable methods. For the PTV 125 to properly function, the mirror 131 and optical unit may need to be adjusted or replaced to optimally direct light images originating from the optical unit onto the new screen.

In another embodiment of the present invention, the width of the cabinetry 150 is varied by substituting the shelf panels 149 with different length shelf panels, the outer top panels 151 with different length outer top panels, the rear panels 145 with different length rear panels, and the bottom panel 147 with a bottom panel that is substantially equal in length to the system 100 incorporating the substitute panels. Further, a substitute toe rail may be provided that is substantially equal in length to the new bottom panel, if a toe rail 181 was originally used or if a toe rail is now desired. Also, substitute doors may be provided that are substantially equal in length to the substitute rear panels. In this embodiment, a user is able to vary the length of system 100 without replacing the PTV 125.

Also, as depicted in FIG. 5, an embodiment of the system 50 of the present invention includes a plurality of cabinetry portions that may be attached to any one side of the system 50 to increase the length of the system 50 on one or both sides. The system 50 includes the PTV 125 and cabinetry 32 attachable to the sides of the PTV 125. The PTV 125 is substantially the same the PTV 125 included with systems 10 and 100. Additionally, the cabinetry portions 32 are substantially the same as the cabinetry 12 and 150 of systems 10 and 100. For example, the cabinetry 32 includes side panels 33 that are adaptable for attachment to a side of the PTV 125. The cabinetry 32 also preferably includes doors 38 positioned at the front of the cabinetry 32 and corresponding handles 36 preferably provided in order to facilitate the opening and closing of the doors 38. A plurality of shelves 34 are also provided that may be positioned at various elevations within ach the cabinetry 32. The shelves 34 are adjustably positioned within the cabinetry 32.

In the system 50, however, the cabinetry 32 differs from the cabinetry 12 and 150 of systems 10 and 100 in that the cabinetry 32 includes an outer side panel 35 in spaced relation from at least one of the side panels 33 wherein the outer side panel 35 also includes attachment components or means to attach another cabinetry portion 32 by connecting the side panel 33 of one cabinetry portion 32 with the outer side 35 of the other cabinetry portion 32.

The present invention, although depicted as rectangular in shape in, for example, FIG. 1, is capable of being manufactured in a variety of shapes by varying the shapes of the panels. The shape of the present invention may also be varied by manufacturing panels that are attached to other panels at various angles other than ninety degrees.

The particular examples set forth herein are instructional and should not be interpreted as limitations on the applications to which those of ordinary skill are able to apply this device. Modifications and other uses are available to those skilled in the art which are encompassed within the spirit of the invention as defined by the scope of the following claims.

What is claimed is:

1. A projection television system comprising:
a projection television set having first and second side panels, and
a cabinet comprising an inner side panel and an outer side panel, a plurality of shelf panels disposed between the inner side panel and the outer side panel of the cabinet, wherein the inner side panel is releasably coupled to the first side panel of the projection television set.

2. The system of claim 1 wherein the cabinet further comprises a second inner side panel and a second outer side panel, a second plurality of shelf panels disposed between the second inner side panel and the second outer side panel of the cabinet, wherein the second inner side panel is releasably coupled to the second side panel of the projection television set.

3. The system of claim 2 further comprising a rail extending along the bottom of the projection television system and connecting to the outer side panel and the second outer side panel.

4. The system of claim 1 further comprising a bus extending along the inner side panel of the cabinet.

5. The system of claim 4 wherein the bus includes a power transmission line.

6. The system of claim 4 wherein the bus includes IEEE 1394 wiring.

7. The system of claim 1 further comprising a plurality of doors attached to the cabinet.

8. The system of claim 6 further comprising a second bus extending along the second inner side panel of the cabinet.

9. An integrated television entertainment center system comprising:
a projection television having an enclosure housing a screen, a mirror optically coupled to the screen, and an optical unit configured to direct light images to the mirror, and
a cabinet comprising
first and second inner side panels, the first and second inner side panels mounted on opposing sides of the screen of the projection television to form first and second side panels of the enclosure of the projection television,
first and second outer side panels, each outer side panel located opposite an inner panel, and
a plurality of shelf panels, each shelf panel attachable between an inner side panel and an outer side panel.

10. The system of claim 9 further comprising a rail connecting the bottom ends of the outer and inner side panels.

11. The system of claim 9 further comprising a bus extending along the first inner side panel.

12. The system of claim 11 wherein the bus includes a power transmission line.

13. The system of claim 11 wherein the bus includes IEEE 1394 wiring.

14. The system of claim 13 further comprising a second bus extending along the second inner side panel.

15. The system of claim 9 further comprising a door mounted between each inner side panel and outer side panel.

16. The system of claim 9 wherein the screen is interchangeable for another screen of a different size.

17. An modular, integrated projection television entertainment center system comprising:
a projection television having a screen, a mirror optically coupled to the screen, and an optical unit mounted in an enclosure having first and second side panels, the side panels having attachment components, and
a plurality of cabinet portions, each cabinet portion having a first side panel with attachment components adapted to releasably engage the attachment components of the side panels of the projection television.

18. The system of claim 17 further comprising a bus extending along the first side panel of the cabinet portions.

19. The system of claim 18 wherein the bus includes a power transmission line.

20. The system of claim 18 wherein the bus includes IEEE 1394 wiring.
